(19) United States
(12) Patent Application Publication
(10) Pub. No.: US 2009/0089042 A1
(43) Pub. Date: Apr. 2, 2009

(54) System and method for interpreter selection and connection to communication devices

(76) Inventors: Samuel Joseph Wald, Brookline, MA (US); Israel Mayer Stein, Chestnut Hill, MA (US)

Correspondence Address: Kenneth J. LuKacher;South Winton Court, Suite 301, 3136 Winton Road South, Rochester, NY, 14623, US

(21) Appl. No.: 12/006,492

(22) Filed: Jan. 3, 2008

Related U.S. Application Data
(60) Provisional application No. 60/878,502, filed on Jan. 3, 2007.
(60) Provisional application No. 61/005,164, filed on Dec. 3, 2007.

(51) Int. Cl. G06F 17/28

(52) U.S. Cl. 704/2

(57) ABSTRACT

A system having a computer system with one or more interfaces enabling communication with one or more communication devices, and memory storing a first database associating geographic regions with the most commonly spoken language(s) of those regions, and a second database associating interpreters with different languages, and a third database providing demographics of members who previously enrolled with the service and including information such as telephone numbers and languages spoken. In response to a requesting communication device, the computer system determines the language(s) spoken by the member associated with that requesting device as identified in the third database, determines a geographic region associated with the requesting communication device and a language of that region as identified by the first database, and selects a matching interpreter from the second database who can assist in both the regional language and one of the languages spoken by the member. The requesting communication device is connected to the communication device of the selected interpreter for either voice communication or text messaging with the user of the device. The requesting communication device may be associated with either a single user or with one of multiple participants associated with a request to the computer system to connect such participants in a multi-party call. In another embodiment, the second database is used to identify interpreters to assist in multi-party conferences or conference calls through remote audio links, in which a series of switches and volume adjustments are used to prevent distraction during simultaneous interpretation for selected participants.

This application claims the priority benefit of U.S. Provisional Application Nos. 60/878,502, filed Jan. 3, 2007, and 60/005,164, filed Dec. 3, 2007, which are herein incorporated by reference.

### FIELD OF THE INVENTION

The present invention relates to a system and method for interpreter selection and connection to communication devices, and relates particularly to a system having a computer system for selecting the proper interpreter for interpretation of the language of a user of a communication device, such as a cellular telephone, for a single party in the case of a voice call or text message, or for selecting one or more interpreters for participant(s) in a multi-party call having participants conversant in two or more different languages. The system is useful for enabling automatic selection of interpreter to the communication device in response to a voice call or text message using a cellular based connection to the particular language of the caller, and for enabling multiple participants in a conference call who speak different languages to be connected, via their devices enabling cellular, land, VoIP, or other means for voice communication, to one or more interpreters that are automatically selected and connected in the conference call where the presence of such one or more interpreters does not distract the participants in the call.

### BACKGROUND OF THE INVENTION

To provide communication with callers who speak different languages requires a caller to identify his or her language typically by a telephone response system which prompts the caller to identify the desired language by voice or tone (key selection) such that they can be connected to an interpreter or agent who can then process the caller's request. However, these telephone response systems become both complex and cumbersome to callers when interpretation is required in each one of multiple different languages which may have different regional forms thereof. Accordingly, there exists a need to automatically select the proper interpreter or agent for the language pair needed by a caller which avoids delay and the probability of connecting the caller with an interpreter not capable of providing proper interpretation. Such automatic selection of the proper interpreter also is desirable in other types of communications, such as when there are two or more participants in a call who do not all speak a common language. This benefits the caller because he does not have to have an interpreter readily available at all times. Moreover, a system for automatic interpreter selection makes connection to telephone or remote interpreters simpler, because such system by already having the language(s) of the system's subscribing users are conversant in, and such user speaking any language can connect without requiring an operator or automated prompts in his own language. Interpreter(s) in conference calls, i.e., calls with more than two participants, while interpreting for participants often are distracting to other participants of the conference call who do not need such interpretation (i.e., oral translation). Such distraction may also occur in other types of conferencing situations having remotely-based interpreters. Thus, in addition to automatic selection of interpreter for a conference call, it would also be desirable that the interpreter(s) are connected in the conference in a manner that minimizes such possible distraction.

### SUMMARY OF THE INVENTION

Accordingly, one object of the present invention is to provide an improved system and method for interpreter selection for the language of a user of a communication device that occurs automatically and which may be used for one or multi-party calls. Another object of the present invention is to provide a system and method for interpreter selection which is made available to only authorized users, such as members or institutions subscribing to the system and the language(s) for each of the users is defined at sign up of the user to the system.

Another object of the present invention is to provide a system and method for interpreter selection in which the system when contacted by a caller can automatically select an interpreter capable of interpreting between one of the predefined language(s) of the user and a language of one either the caller or a geographic region associated with the requesting communication device; A still further object of the present invention is to provide a system for selection of one or more interpreters in a conference call with two or more participants without distraction of conference call participants by the presence of such one or more interpreters.

Briefly described, the present invention embodies a system having a computer system with one or more interfaces enabling communication with one or more communication devices, and memory storing a membership database, defining the users of the system, stored in said memory having identifying information to identify the communication device of each of the members, and associating the users with language(s), a regional language database associating geographic regions with different languages; and a interpreter database associating interpreters with pairs of different languages each of said interpreters are capable of interpreting between. In response to a requesting communication device, the computer system identifies the requesting communication device as being associated with one of the members in accordance the identifying information of the membership database, determines a geographic region associated with the requesting communication device, selects one of said languages associated with the geographic region associated with the requesting communication device in accordance with said regional language database, and selects an interpreter associated with the pair of the selected language and one of the language(s) of the identified member for connection with the requesting communication device in accordance with the interpreter third database. The requesting communication device may then be connected to the communication device of the selected interpreter for either voice communication or text messaging with the user of the device.

The requesting communication device may be a cellular or wireless based communication device such as a cellular telephone, PDA, or a personal computer, laptop, or other microprocessor based system capable of connecting to the computer system. One benefit of the membership database of members is that its includes a list of all languages that each member can communicate so that the possibility of finding an available interpreter to assist is multiplied by the number of languages the member speaks.

The interpreter may provide the caller with assistance in accordance with the needs of the caller, such as medical, tourist, movie, theater, directions, or other information services, or in the case where the interpreter represents a customer service or technical service agent for a company, who may provide such customer service as requested by the caller.

In another embodiment, the regional language database is not used or present, and the users represent institutions, such that the membership database is referred to an institution database represents a database of subscribing institutions, rather than members. In this embodiment, the computer system in response to a call of a requesting communication device, identifying the call as being associated one of the institutions in accordance the identifying information of the institution database, enables the caller on the communication device to select one of different languages the caller is conversant in, and selects an interpreter associated with the pair of the caller selected language and one of language(s) of the identified institution for connection with the requesting communication device in accordance with the interpreter.

The present invention also embodies a method for providing a computer system and an interpreter database associating interpreters with pairs of different languages each of interpreters are capable of interpreting between, selecting one of the languages associated with one of a caller of the requesting communication device or a geographic region associated with the requesting communication device, selecting an interpreter automatically in accordance with the interpreter database for interpreting between one of the pairs of the selected language and one or more predetermined languages, and connecting the interpreter with the requesting communication device.

In another embodiment the regional language and membership/institution databases are not used or present, and a caller to the computer system represents one of multiple participants associated with a request to the computer system to provide a conference call between the participants conversant in two or more different languages, where each participant has a communication device for connecting to the computer system and one of the different languages represents a main language associated with one or more of the participants and another of the different languages represents the selected language. The computer system for each participant conversant in one of the different languages other than the main language, selects a different interpreter for interpreting between the main language and reselected language of each participant using the interpreter database. Next, the computer system connects each of the participants requiring interpretation (i.e. oral translation) in each one of the one or more different languages other than the main language with one of the selected interpreters, and establishes a conference call between communication devices of each of the participants conversant in the main language and the selected interpreters.

Preferably to avoid distraction among participants in the conference call, the communication device of each participant requiring oral translation has a one-way receive only connection with the conference call in the main language at a volume level adjustable at the communication device by the participant. Thus, the participants conversant in the main language hear other participant conversant in the main language and the interpreter in the main language interpreting for each one the participant conversant in a different language than the main language, rather than the participant speaking the different language. Optionally, the communication device of each of said participants requiring oral translation is selectable by the participant between a one-way receive only connection or a two-way connection with the conference call in the main language.

The communication device of one or more of the participants represents a microprocessor-based system operative to provide two-way voice communication, such as a personal computer, laptop, or cellular phone, and the microprocessor-based system has a display identifying each of the participants and when each one of said participants is speaking. Such display may be a visual display on the screen on the computer system or an external display connected to a microprocessor-based system or the computer system. Further such microprocessor based system may have an interface, such as a touch screen, keys, or toggle enabling one of the participants to notify other participants of an intention to speak in the conference.

The system may further be used in conference call, or in a conference in an auditorium, lecture hall, or the like, using one or more remotely-based interpreters, where the each attendee conversant in the non-main language of the conference has a communication device automatically connected by the computer system with an interpreter selected from the interpreter database for interpreting between the attendee's non-main language and the main language openly spoken in the conference, where the interpreter has a communication device in two-way connection with another communication device resident in the conference for conversing in the main language.

### BRIEF DESCRIPTION OF THE DRAWINGS

The foregoing and other features, objects, and advantages of the invention will become more apparent from a reading of the following detailed description in connection with the accompanying drawings, in which:

FIG. 1 is a block diagram of the system of the present invention;

FIGS. 2A and 2B are a connected flow chart showing the processing of the system of FIG. 1 for connecting a requesting communication device or a member with a selected interpreter;

FIG. 3 is a another flow chart showing the processing of the system of FIG. 1 for connecting a requesting communication device with a selected interpreter in which the requesting communication device represents a customer of an institution requiring interpretation to interact with staff of the institution;

FIGS. 4, 5, and 6 are three schematic examples of diagram showing the connections between multiple participants to a conference call and one or more interpreters; and

FIG. 7 is a process diagram of the organizing of a conference call in the system of FIG. 1.

### DETAILED DESCRIPTION OF THE INVENTION

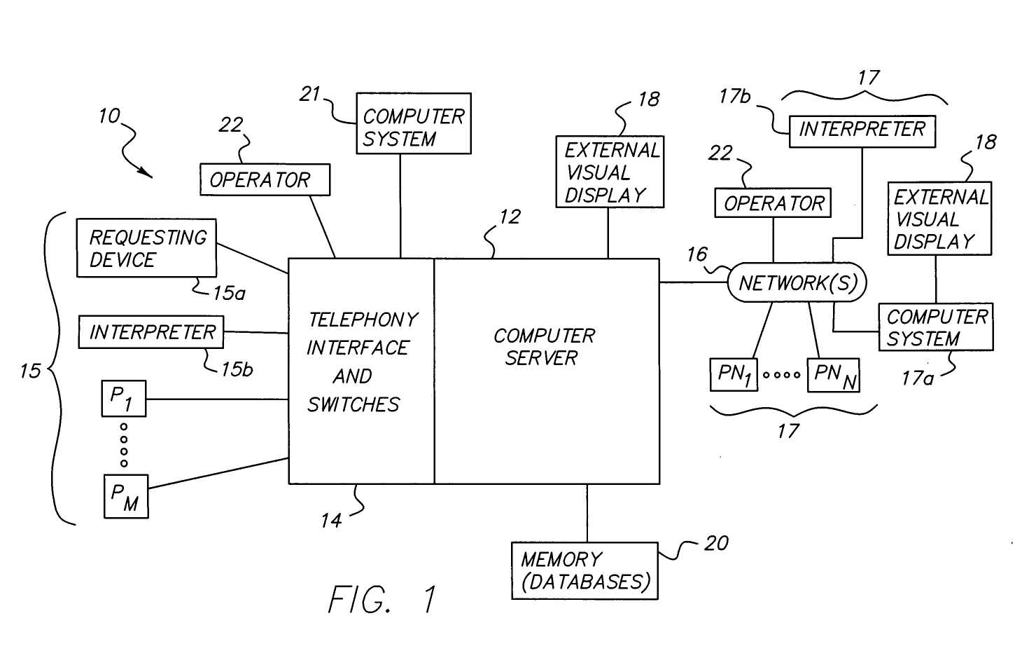

Referring to FIG. 1, the system 10 has a computer system 12 which may be a computer server, a telephony interface 14 having logic and switches for connecting to the one or more communication devices 15 to computer system 12 in response to such communication devices calling one or more telephone numbers assigned to system 10, making out bound calls at phone numbers assigned to one or more communication device 15, and also to enable the computer system to connect (or bridge) one or more of such communication devices 15 with each other (or with network 16 based communication devices 17) in two or more multi-party calls. The interface 14 may also enable the computer system 12 to receive text messages from and send text messages to those communication devices 15 that have text messaging capability. The computer system 12 also has network interfaces for communication over one or more networks 16, such as a LAN, WAN, or Internet (preferably including at least the Internet), with network based communication devices 17, such as by Voice Over IP (VoIP) software, or computer systems (or other microprocessor based systems or devices) 17a capable of connection to the computer system 12 over network(s) 16. The interface 14 may further enable the computer system 12 to connect one of communication device 15a for text messaging with another of communication devices 15b or with communication device 17b, where both connected devices have text messaging capability.

Computer system 21 represents a microprocessor-based system or device capable of communication with computer system 12, via interface 14, by calling such one or more phone numbers assigned to system 10. Computer systems 17a and 21 each are programmed to enable a user, via the user interface (e.g., touch screen, keyboard, mouse, or the like) of such systems, to enable a graphical user interface (GUI) to send a request to computer system 12 to establish a two or more multi-party call in which one or more participant are conversant in different languages. For example, computer systems 17a or 21 may be personal computer, laptop, PDA, or cellular phone a GUI for enabling the computer system, as will be described later. Computer system 10 although illustrated as single block in FIG. 1 may represent one or more computer systems or servers.

The computer system 12 is connected to memory 20 which may be an external memory unit, or an internal memory (RAM) or drive of the computer system, or combination thereof storing the programming for operating the system and databases: a Regional Language Database associating geographic regions with the most common language(s) spoken in those regions, a Interpreter Database associating interpreters with language pairs for which the interpreters can interpret and with identification information, for example the phone number of the interpreter, and a Membership Database which includes subscribing users (i.e., individuals and/or institutions and may be occasionally referred to herein as an Institution Database when discussing institutional subscribers) associating users with identification information, e.g., the phone number of the member or institution for identifying an incoming call to interface 14 as being associated with one of the members or institutions and the language(s) spoken by the member or institutional employees.

Communication devices 15 preferably are cellular or wireless based communication devices, such as mobile cellular telephones, PDAs, or personal computers, laptops, or other microprocessor based systems capable of communication with computer system 12. The connection to interface 14 from devices 15 or system 21 may further include in additional to use of a cellular based communication may utilize a Public Switch Telephone Network (PSTN) in their connection to interface 14. In the case of multi-party calls, one or more of the communication devices 15 may optionally be a typical non-cellular land communication device, e.g., telephone. In addition to computer system 12 having typical software for enabling server operation, computer system 12 further has software for determining (or requesting) a geographic location of any one of the communication devices 15 which are GPS enabled (i.e., have hardware/software for using the Global Positioning System (GPS) by GPS signals to detect device location), or by triangulation to determine location of the devices 15. Such software at computer system 12 may be similar to that conventionally use to locate the geographic location or region of a cellular based phone or wireless mobile system, and is not limited to GPS or triangulation methods.

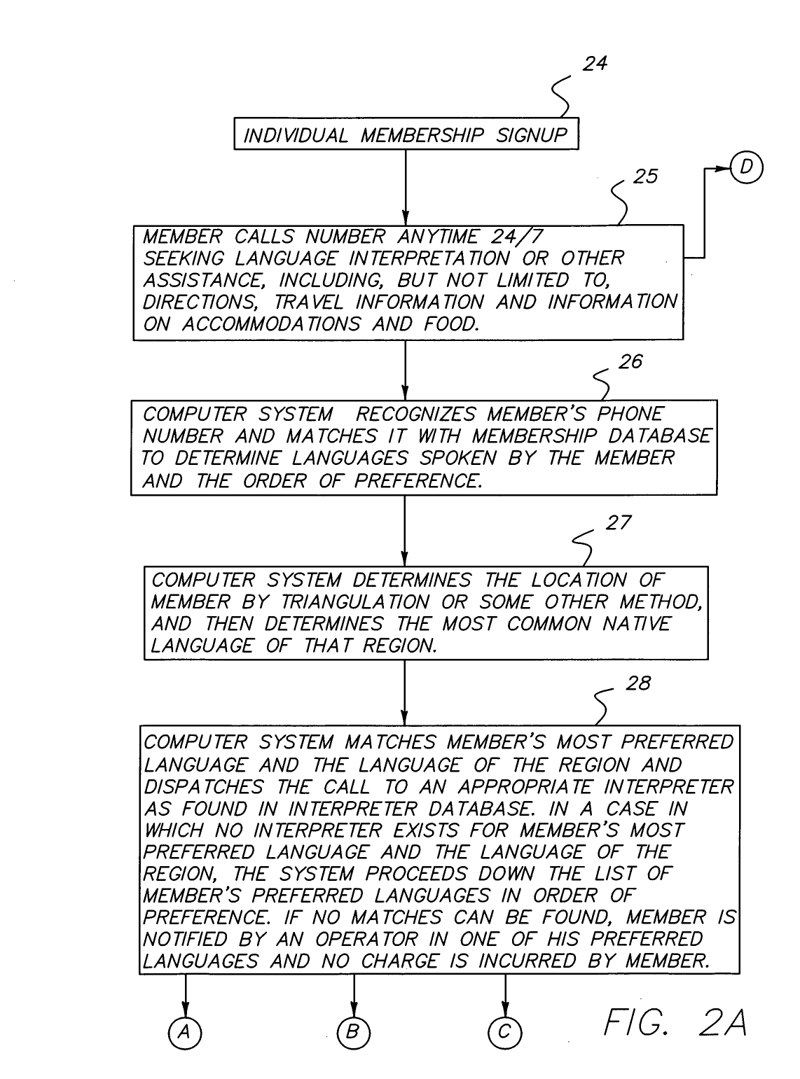

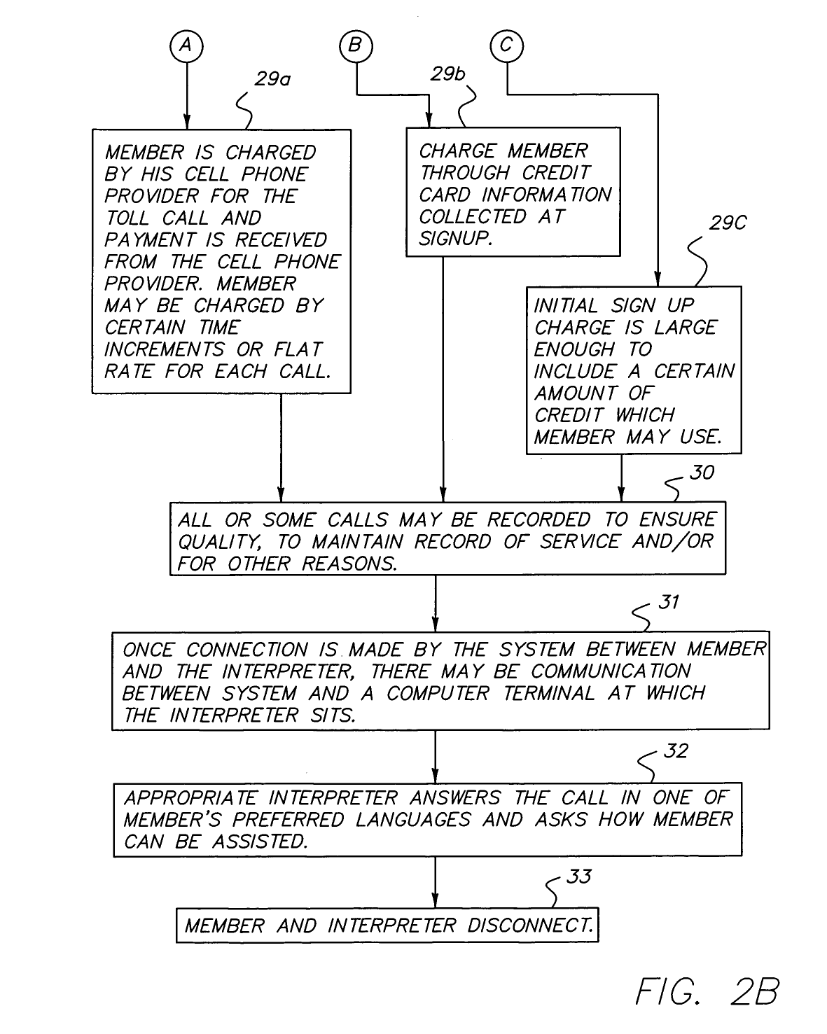

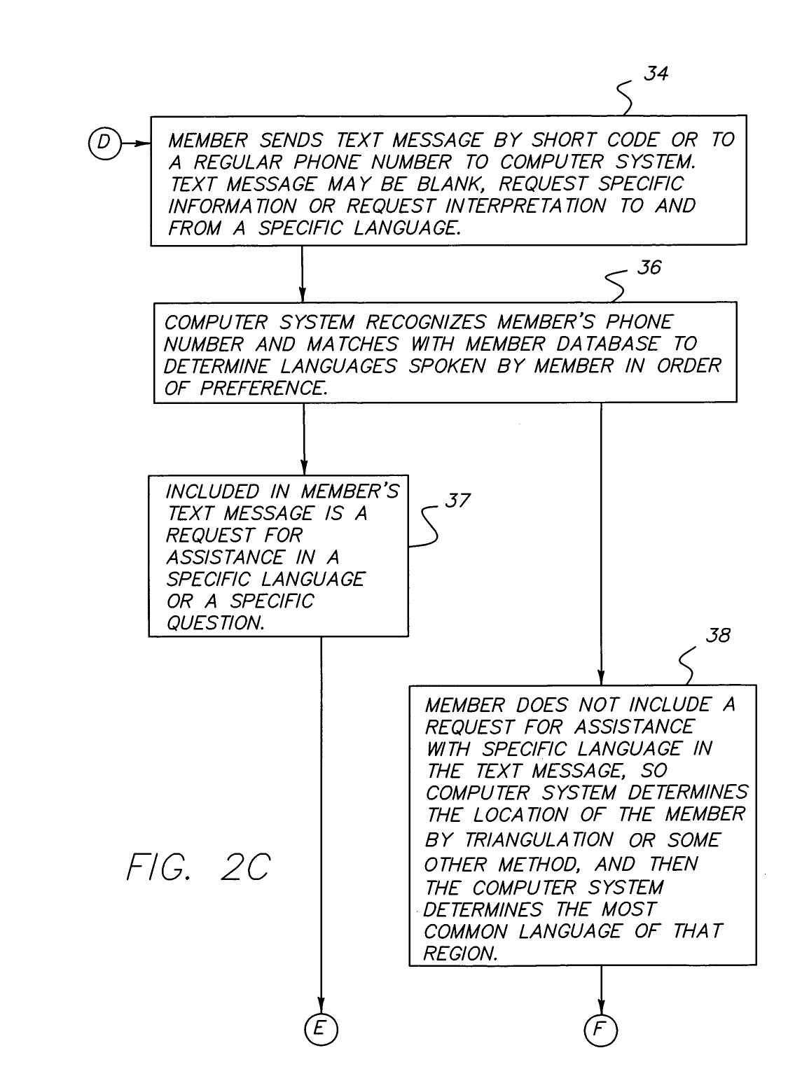

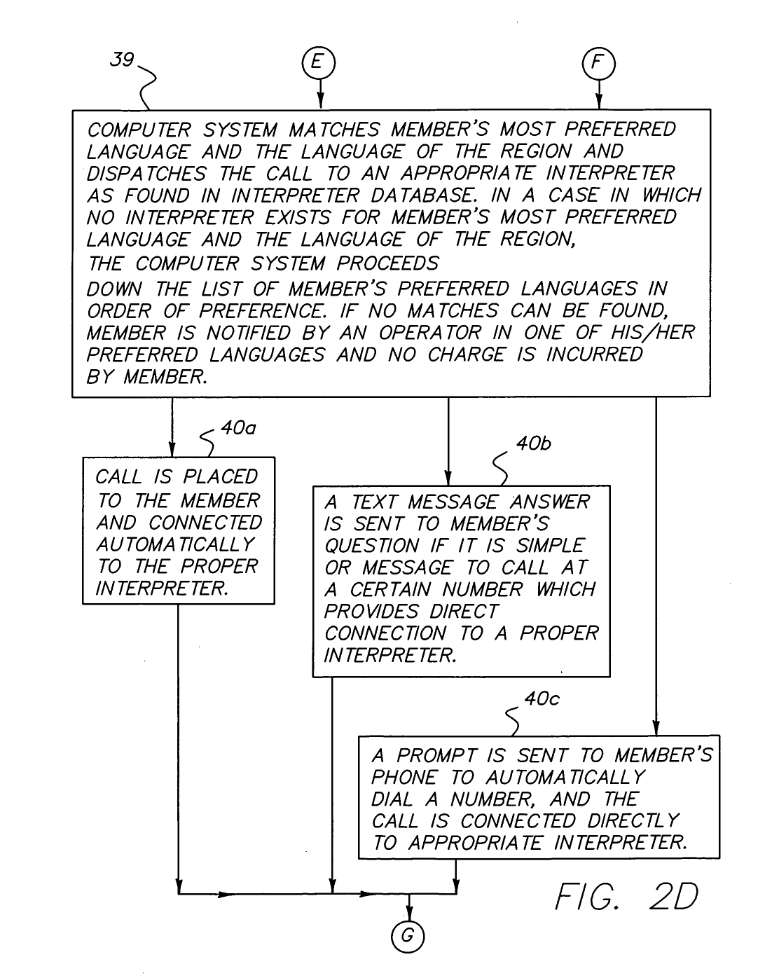

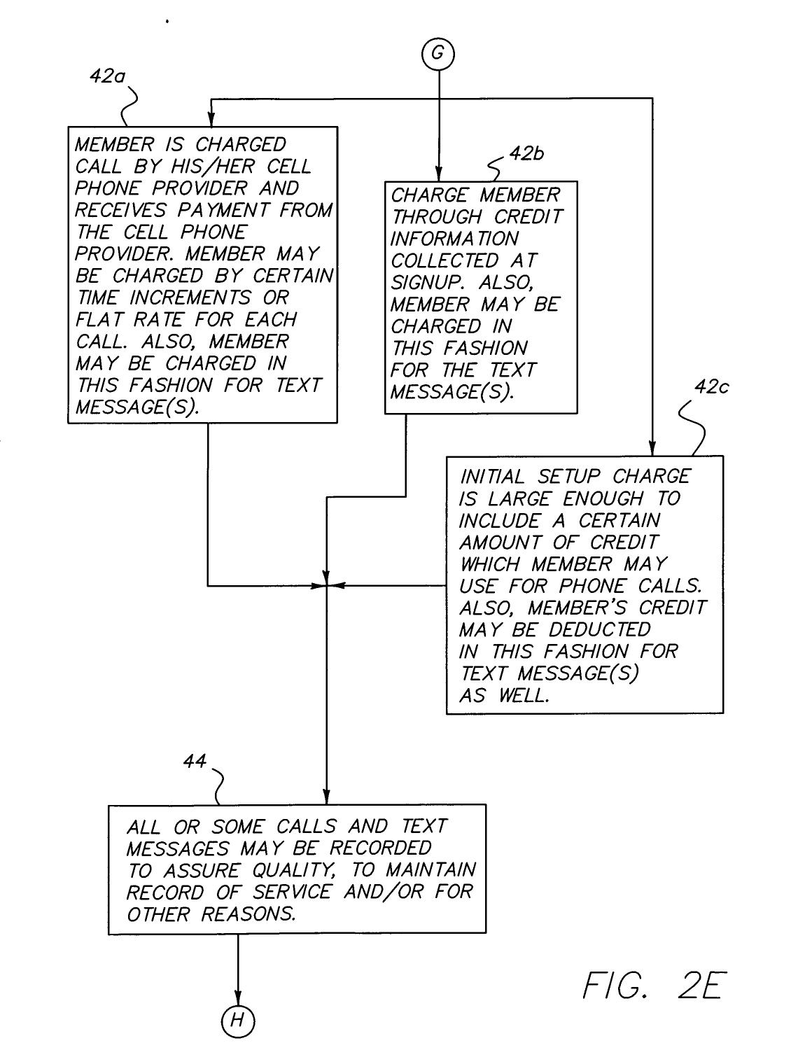

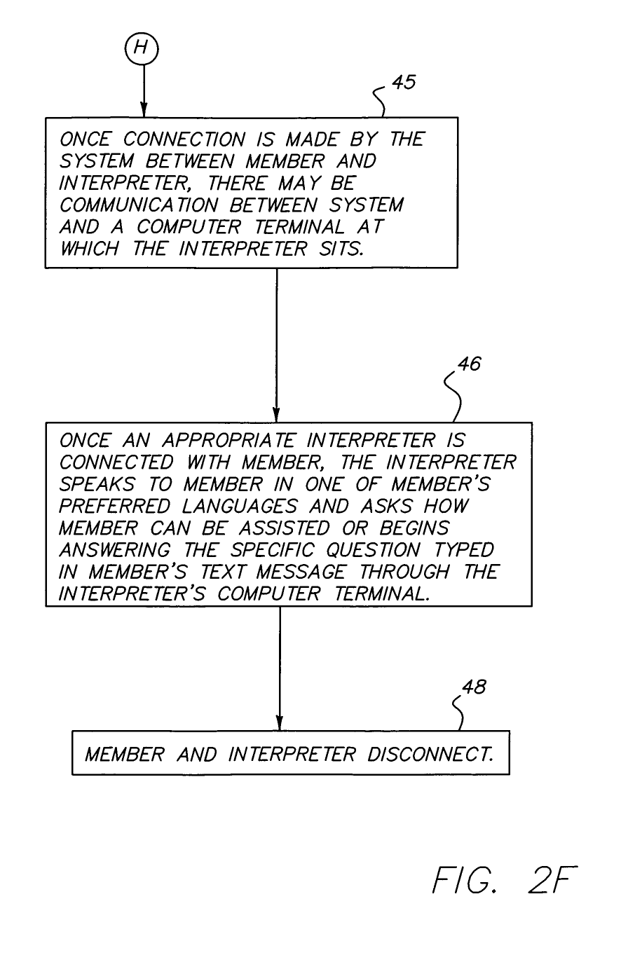

Referring to FIGS. 2A and 2B, a flow chart of the operation of system 10 is shown for enabling interpretation and assistance on behalf of individuals (or users) on the communication devices 15. FIGS. 2A and 2B are connected flow charts by circled A or B. The flow chart shows the method by which the computer system 12 is programmed to identify the needs and capabilities of one of the communication device 15 referred to herein as the communication device 15a of a subscribing member or user in system 10. The system 10 facilitates communication (or interaction) between individual members around the world and over-the-phone interpreters at their communication devices 15b or 17b. Thus it eases the process of interpretation and assistance. For purposes of illustration only two interpreter communication devices are shown, any number of such devices may enable an interpreter to connect to the computer system 12. Further, there may be more than one requesting communication device 15a may connect to computer system 12 to enable system 10 to interact with multiple members at the same time. By compiling and storing databases in memory 20, as described in more detail below, and matching the proper information from each database for each requesting (incoming) member contact via her/her communication device 15a, quickly and automatically the system matches a contacting member with the proper interpreter/agent who can communicate with the member in his/her language and can also assist in the local language of the geographic region from which the member is making the contact without requiring the member to identify any of the one or more local languages of the region he or she is with device 15a. As will be described below, the system 10 matches information determined upon contact or connection with computer system 12 (i.e., the geographic location or region where the communication device 15a is located) and then uses the Regional Language and Interpreter Databases to select an interpreter who can facilitate the interaction between the member and other individuals with whom the member needs to interact.

Before beginning use of system 10, an individual member (or client) signs up on system 10. (step 24). To do this, the member may pay a fee, agree to a contract, and provides member information including, but not limited to, a name, cell phone provider and number, and a list of preferred languages client is conversant in, i.e., can speak and understand, in order of preference. This information may be entered by a computer system 12 providing an addressable web site with one or more web pages that a member can download having fields providing an on-line form to enter the member information. Other ways of collecting member information may be via forms mailed into a center for entry into the on-line form, or via an operator of a calling center. The member information, which may be that of an individual or an institution, is compiled from each member to create the Membership database having records for each member of system 10. The Regional Language Database provides a list of different regions of the world with the language(s) commonly spoken in each region. The Interpreter Database consists of a list of interpreters/agents who are available to work in each language. This database is continually updated based on work schedules of the interpreters, so that only those who are presently on duty are indicated as available in the database. An example of the Interpreter Database is shown below:

### Example Interpreter Database

### Date and Time: Oct. 24, 2009, 12:34:58 pm

| interpreter | | | | | | |
|---|---|---|---|---|---|---|
| ID | Language 1 | Language 2 | Consecutive | Simultaneous | On duty? | Available? |
| xxx abc | English | Spanish | yes | no | Yes | no |
| xyx abc | English | French | yes | no | No | — |
| xyy efg | English | German | yes | yes | Yes | yes |
| xxy mnt | English | Mandarin | yes | yes | No | — |
| yxx gfd | English | Japanese | yes | no | Yes | yes |
| yxy pre | French | Cantonese | yes | yes | Yes | no |
| yxy bcx | French | Dutch | yes | yes | Yes | yes |
| yyx zsa | French | Japanese | no | yes | No | — |
| yyy ert | French | Punjabi | yes | no | Yes | yes |
| xxx bvq | German | Hindi | yes | no | Yes | no |
| xxx jky | German | Japanese | no | yes | Yes | yes |

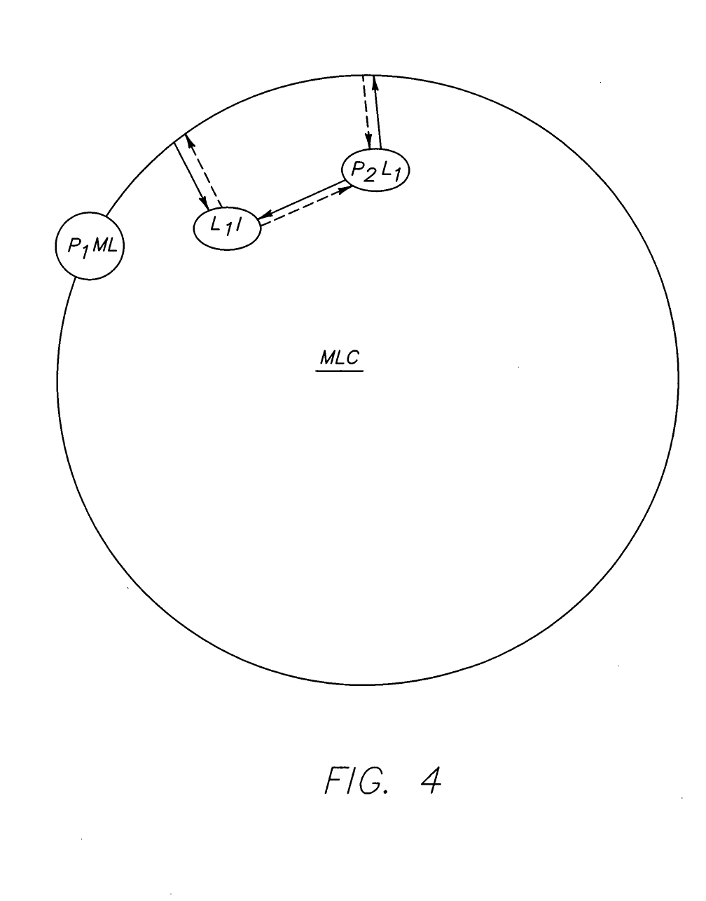

“Interpreter ID” is the identification of an ID code or name of the interpreter. “Language 1” is one of the languages in a language pair from which or into which the interpreter can interpret. “Language 2” is the other language in a language pair from which or into which the interpreter can interpret. If a an interpreter can interpret between more than two language pairs, the interpreter may have additional entries under the same interpreter ID for each of such language pairs. “Consecutive” is a yes or no (e.g., flag or field), where if set to “yes” means that the interpreter is capable of providing consecutive interpretation for that language pair, and is otherwise set to “no”. “Simultaneous” is a yes or no (e.g., flag or field), where if set to “yes” means that the interpreter is capable of providing simultaneous interpretation for that language pair, and is otherwise set to “no”. “On duty?” is a yes or no (e.g., flag or field), where if set to “yes” means that the interpreter is on duty at the moment identified by the “Date and Time”, and if otherwise set to “no”. “Available?” is a field that can be set to “yes”, “no”, or “-”; where, “yes” means that the interpreter is on duty at the moment, and not on another call or scheduled for another pre-scheduled call; “no” means that the interpreter is on duty at the moment, but is waiting for another call or scheduled to begin another prescheduled call; and “-” means that the interpreter is not on duty. The Interpreter Database is updated by the computer system 12 automatically in real-time indicating the status of the interpreters as to whether the interpreter is on duty and, if so, available as connections are enabled and disabled by the computer system 12 with members' communication devices. In the case of FIGS. 2A and 2B, the fields for “Consecutive” and “Simultaneous” need not be used or present in the Interpreter Database, such fields are used in the embodiment of system 10 described later in connection with FIGS. 4-7. Other data structures than those shown in the above example Interpreter Database may also be used having the same or similar information.

When an individual member contacts the service (via one or more telephone numbers assigned to system 10 for communication) via a requesting communication device 15a for interpreter assistance by a cell phone call (step 25), the computer system 12 receives the call via interface 14 and obtains the calling member of the member's phone number (as typically data provided by the cellular service provider of the member with an incoming cellular phone call), and then searches the member information of the Membership Database for a match with such calling number. If found, the computer system 12, identifies the member's preferred languages in order, as listed in the Membership Database in the member information associated with the calling member (step 26).

The computer system 12 determines the member's general geographic region or location through triangulation, GPS or other method, and searches, through the Regional Language Database, selects (matches) that region or location with commonly spoken languages of the region (step 27).

The computer system 12 then searches the Interpreter Database for an interpreter (agent or operator) who can work with one of the member's preferred languages and with the selected regional language (step 28). Using the Example Interpreter Database, the computer system 12 searches for a Language 1 and Language 2 pair, in any order that matches the first preferred language and one of the selected geographic regional languages. The computer system 12 searches first for a match with a pair having the member's most preferred language and one of the selected geographic regional languages, and if none are found then proceeds down the next one on list of preferred languages (if more than one is provided) and one of the selected geographic regional language. As by example, using the Example Interpreter Database above, a member traveling in London who speaks Spanish, French and German, in that order of preference, but no English, calls on his cellular phone. His location is identified, and English is identified as the regional language. The languages he speaks are identified, and the system then tries to match a pairing of English and his languages (in order). First, the system tries Spanish-English, but while an English-Spanish interpreter is on duty, that interpreter is not currently available. Next, the system tries English-French, but there is no such interpreter on duty. Then the system tries English-German and finds interpreter identified as “xyy efg” and connects that interpreter to the member.

If an interpreter is selected in the Interpreter Database having a matching language pair, and the interpreter is available, i.e., the “Available?” set to “yes”, then at step 28, the member is connected to the appropriate interpreter, where computer system 12 instructs the interface 14 to connect (or bridge) the requesting communication device 15a of the member to the communication device 15b of the selected interpreter. If the interpreter is at a communication device 17a then a connection is made by the computer system 12 by opening voice communication with the device 17a of the selected interpreter and then instructing interface 14 to connect that voice communication with member communication device 15a. The Interpreter Database is updated for the interpreter by the computer system 12 to set the “Available?” to “no”. Once connected, the member is automatically billed via one of 29a, 29b or 29c methods. Although not shown in the above example database, the contacting phone number or address of each of the interpreters is stored in the Interpreter Database and is utilized by computer system 12 to contact the proper interpreter.

If no match can be made, the computer system 12 notifies the member in one of his/her preferred languages that no interpreter is currently available. Notification preferably is a connection of requesting communication device 15a to the communication device of an operator 22 is contacted by the computer system 12 via interface 14 in that preferred language, or an operator having a communication device that can be connected by computer system 12, via network 16, to the requesting communication device 15a.

In the case of step 29a, the member is charged by his cell phone provider for the toll call, and payment will be received from the cell phone provider. In the case of step 29b, the member is charged by certain time increments or flat rate for each call. The member may be charged through credit card information collected at signup or billed through other form of credit account, which may be stored in the Membership Database. In the case of step 29c, at initial sign up the member provided a credit card charge large enough to include certain amount of credit which the member may use. The member may select one of methods 29a,b,c at sign-up. Rates may vary for different language combinations. Alternatively, other credit arrangements or a pre-paid card may be used. Optionally at step 30, all or some calls may be recorded to ensure quality, to maintain record of service and/or for other reasons.

The interpreter may be residing at another computer system or terminal which can communicate with computer system 12, such as via network 16 to enable communication between the computer system 12 and a computer terminal at which the interpreter sits, such as via network 16 to the interpreter's computer system. Such communication between the computer system 12 and the computer terminal at the location of the interpreter may be for assisting the interpreter during the call and to help us collect information about the call. Further the interpreter may be, for example, an agent or other personnel for a company providing services to the member. When connected, the interpreter at communication device 15b or 17b answers the call in one of member's preferred languages and asks how we can assist member (step 32). The member may place his or her communication device 15a in a speaker mode, or pass the communication device 15a between himself or herself and an individual conversant in the selected regional language. Upon detection of disconnect between interpreter's communication device 15b or 17b and the member's communication device 15a (step 33), the Interpreter Database is updated for the interpreter by the computer system 12 to set the “Available?” to “yes”, and the interpreter is available for another call.

Alternatively, the computer system 12 may operate in response to a requesting communication device 15a by text message, where a text message is sent to the computer system 12, via interface 14, and device 15a has text messaging capability. If by text message, the member receives a response with a text message answer to a question, a text message telling the member to call a specific number to be connected with an interpreter/agent or a phone call directly from an interpreter/agent/operator. Alternatively, the member's phone may receive a signal prompting it to directly dial a number that would connect the member to an interpreter/agent. Steps 34-46 of FIGS. 2A and 2B describe operation of system 10 in response to text message from a member. After step 25, the member sends a text message to a short code or to a regular phone number assigned to computer system 12 for connection to interface 14 (step 34). Text message may be blank, request specific information or request interpretation to and from a specific language. As in step 26 described above, the computer system 12 recognizes member's phone number and matches with the Membership Database to determine languages spoken by member in order of preference (step 36). The member either sends in the text message a request for assistance in a specific language or a specific question (step 37), or the member does not include a request for assistance with a specific language in the text message (step 38), and the computer system 12 determines the location of the member by triangulation or some other method, and then using the Regional Language Database determines the most common language of that region.

At step 39, the computer system 12 selects the interpreter using the Interpreter Database by matching the pair of the member's most preferred language and the selected language of the region, and who is available (i.e., “Available?” set to “yes”). In a case in which no interpreter is available or exists for member's most preferred language and the language of the region, the program proceeds down the list of member's preferred languages in order of preference. If no matches can be found, the member is notified by an operator in one of his preferred languages and no charge is incurred by member. Step 39 may be the same as step 28 described earlier.

The connection made by the computer system 12 between the communication devices of the member and the selected interpreter maybe by steps 40a, 40b, or 40c. If using step 40a, a voice call is placed by the computer system 12 to the communication device 15a of the member and is connected automatically to the proper interpreter's communication device 15b or 17b. If using step 40b, the communication between the communication device 15a of the member and the proper interpreter's communication device 15b or 17b is by text messaging, where the interpreter provides a text message answer to member's question if it is simple enough, or if not simply as determined by the interpreter, a message is sent to member's communication device 15a to call a certain phone number which provides direct connection to a proper interpreter (step 40b). If using step 40c, a prompt is sent to the member's communication device 15a to automatically dial a number, and the call is connected directly to the communication device 15b or 17b of an appropriate interpreter. When text messaging is used to communicate with the member's communication device 15a, the interpreter's communication device 15a or 17b may be a cellular phone, but preferably is a computer system. The option of choices 40a, 40b or 40c is at the discretion of the interpreter or indicated by the preference of the member at sign-up or is determined by the subscription agreement. The Interpreter Database is updated for the interpreter by the computer system 12 to set the “Available?” to “no” if voice communication is established such as described earlier between a member and an interpreter. The member is then automatically billed via one of 42a, 42b or 42c methods.

At step 42a, the member is charged by his cell phone provider for the toll call and payment is received from the cell phone provider. Member may be charged by certain time increments of flat rate for each call. The member may also be charged in this fashion for text message(s). At step 42b, member is charged through credit card information collected at signup or billed through other form of credit account or prepaid card. The member may be charged in this fashion for the text message(s). At step 42c, the initial signup charge is large enough to include a certain amount of credit which member may use for phone calls. Also, member's credit may be deducted in this fashion for text message(s) as well. Rates may vary for different language combinations.

All or some calls and text messages may be recorded to assure quality, to maintain record of service and/or for other reasons (step 44). Once connection is made, there may be communication between computer system 12 and a computer system or terminal at which the interpreter sits (step 45). Such interpreter computer system being described earlier at step 31. Once an appropriate interpreter is connected with the member, the interpreter speaks to member in one of member's preferred languages and asks how we can assist member or begins answering the specific question typed in member's text message through the interpreter's computer terminal (step 46). Upon detection of disconnect between interpreter's communication device 15b or 17b and the member's communication device 15a (step 48), the Interpreter Database is updated for the interpreter by the computer system 12 to set the “Available?” to “yes”.

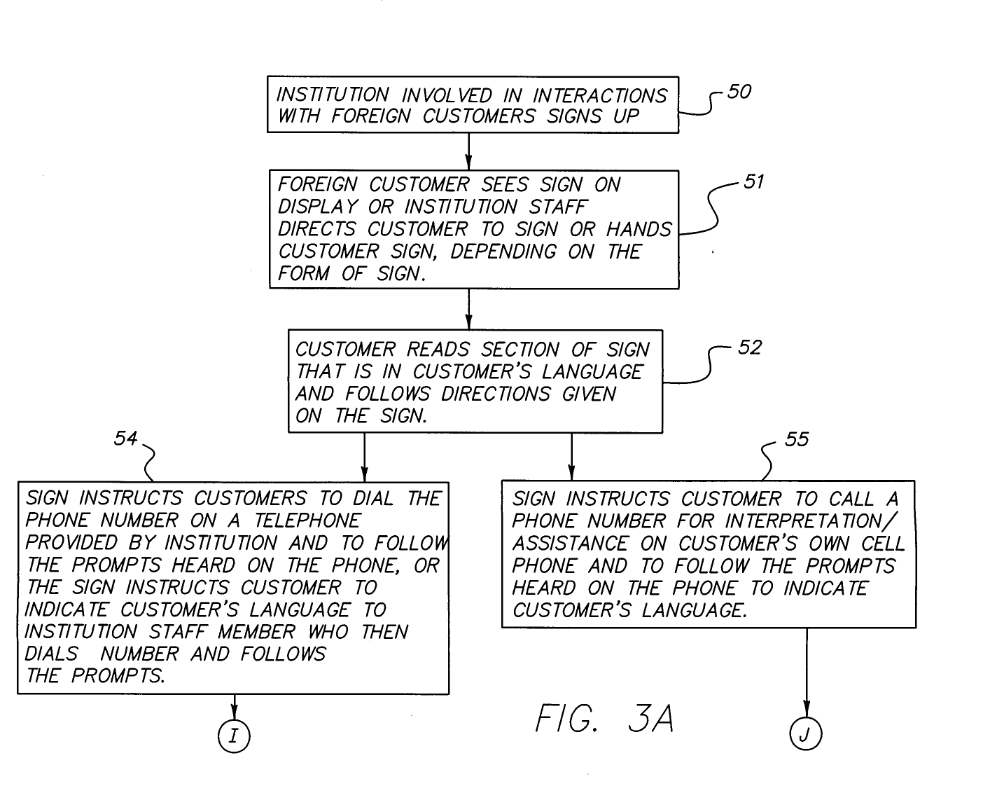

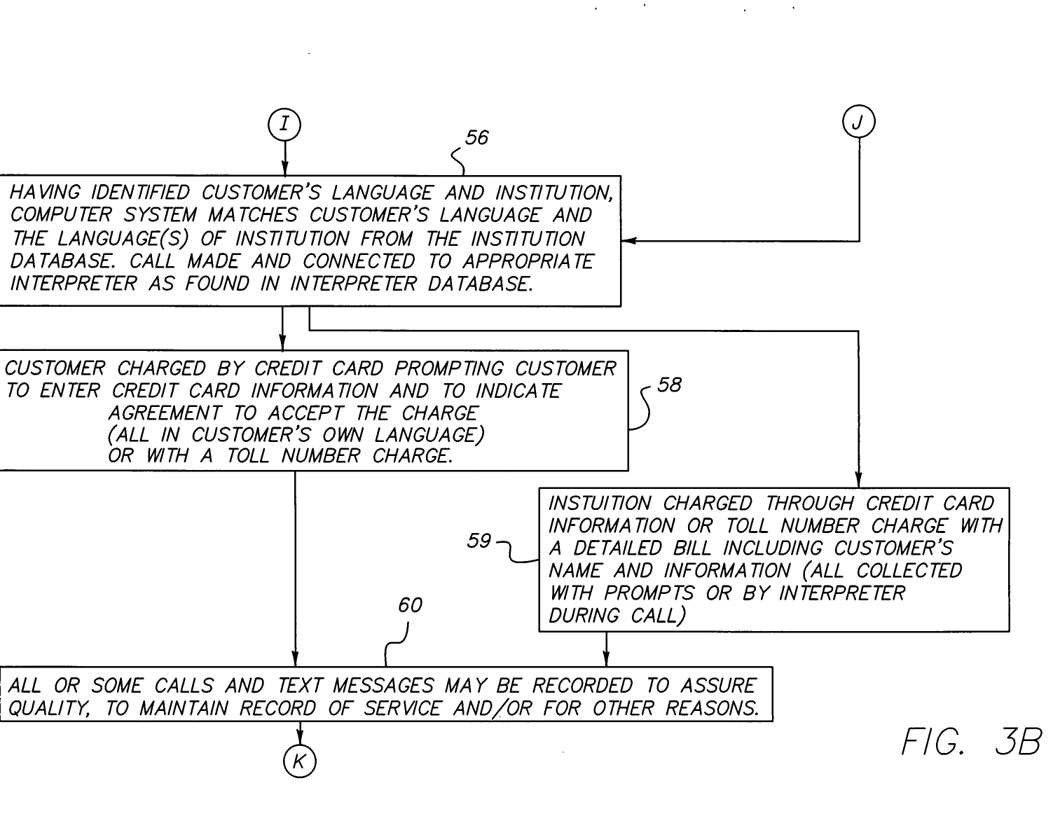

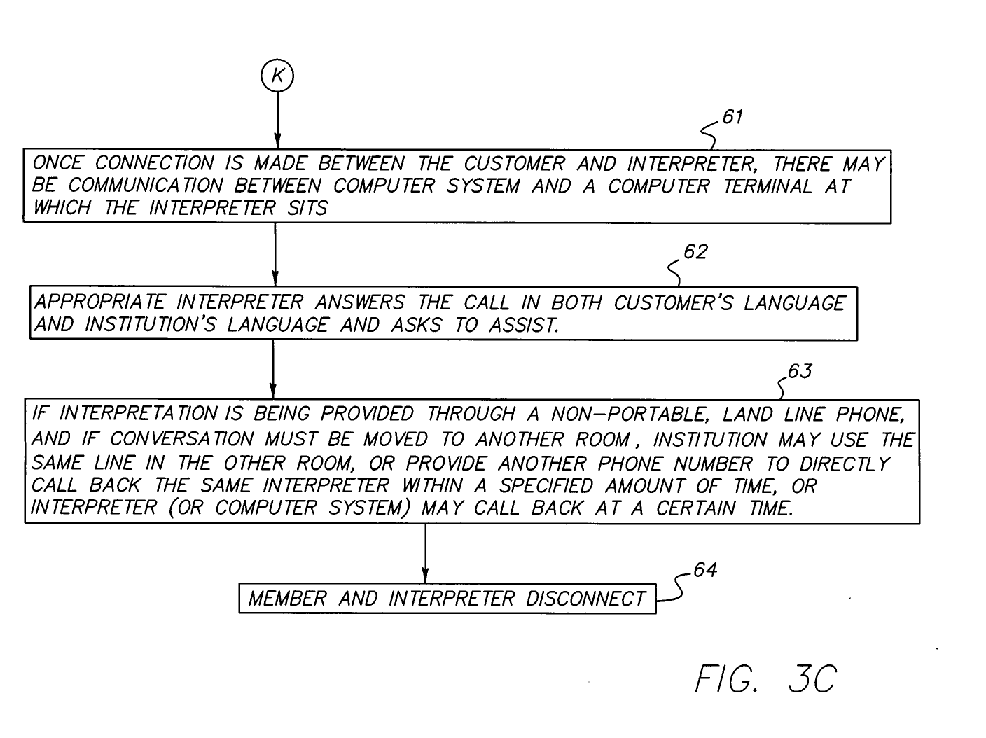

Referring to FIG. 3, a flow chart of the operation of another embodiment of system 10 for interpretation and assistance on behalf of institutions (e.g., medical office, hospital business, police, governmental agency, technical service department, customer service department, residential complex, hotel or other such institution offering private or public services) and their customers using either a cellular or land-based phone system. The flow chart shows the method by which the computer system 12 is programmed to identify the needs and capabilities of the institutions and the calling party requiring interpretation. In this embodiment, the same Interpreter Database is used, but the Membership Database represents multiple institutions or clients, but otherwise has same or comparable information as members described earlier, and thus Membership Database is described in this embodiment as the Institution Database in which institution names are used rather than member names. Instead of location the regional language being determined, the language of the caller to be interpreted is indicated to the computer system 12 in the call, and thus Regional Language database is not used or not provided in memory 20.

Before beginning use of system 10, an institution at step 50 signs up with the system 10 by providing information including, but not limited to, a name, a telephone number (cellular or non-cellular), which is stored in the Institution Database by the computer system and language(s) commonly spoken by its staff members, and a unique PIN number. This information may be entered by a computer system 12 providing an addressable web site with one or more web pages that a representative of the institution can download having fields providing an on-line form to enter the institution information. Other ways of collecting institution information may be via forms mailed into a center for entry into the on-line form, or via an operator of a calling center. The institution information is compiled from each member to create the Institution Database having records for each of the institution.

Either the institution or the institution's customer (i.e., a party with which it has or will interact) contacts the computer system 12 using a requesting communication device 15a (or a telephone via PSTN 19) via interface 14. For example, a customer is provided with (or follows a posted sign) with calling instructions to dial the phone number assigned to the system 10 and following such instructions (steps 51 and 52). The sign instructs the customer to dial such phone number on a telephone provided by the institution to the customer, or a staff member may dial such phone number (step 54). Alternatively, the customer may user his/her cellular phone (or land based phone) to dial the phone number (step 55). The language of the institution's customer is indicated by the caller to the computer system 12 by the computer system providing automated voice prompts to the caller which list the available language(s) on the phone and then pressing the proper buttons to select the language of the caller (step 54).

At step 56, the computer system 12 using the phone number of the calling communication device 15a (such as ANI or cellular phone number) and searches the Institution Database for a matching the phone number with a name of the institution to obtain the language(s) commonly spoken by its staff members as set forth in the Institution Database. If the contact was made from a cell phone or a phone that is not found in the database (such as, the customer's own phone at step 55), the computer system 12 may prompt for a PIN number, such that upon matching a PIN number in the Institution Database the computer system 12 can identify the institution and language(s) associated therewith. Once both languages are obtained, the computer system 12 searches the Interpreter Database to select the appropriate interpreter having the matched language pair (i.e., language indicated by the calling customer, and one of the language(s) associated with the institution from the Institution Database) of an available interpreter (i.e., “Available?” set to “yes”).

The computer system 12 then instructs interface 14 to connect (or bridge) the calling communication device 15a with a communication device 15b or 17b of the selected interpreter. The Interpreter Database is updated for the interpreter by the computer system 12 to set the interpreter's “Available?” set to “no” (step 56). Customer or institution is charged via one of steps 58 or 59, respectively, such as described in FIG. 3. Optionally at step 60, all or some calls may be recorded to ensure quality, to maintain record of service and/or for other reasons.

The interpreter may be residing at another computer system or terminal which can communication with computer system 12, such as via network 16. There may be communication between the computer system 12 and a computer terminal at which the interpreter sits, such as via network 16 to the interpreter's computer system (step 61). Such communication between the computer system 12 and a computer terminal at the location of the interpreter may be for assisting the interpreter during the call and to help us collect information about the call. When connected, the interpreter at communication device 15b or 17b answers the call in both the customer's language and the institution's language and asks how the customer can be assisted. (step 62). If the interpretation is being provided through a non-portable, landline phone, and if conversation must be moved to another room (such as for example, from waiting room to an examining room in a medical office), the institution may use the same line in the other room, or provide another phone number to directly call back the same interpreter within a specified amount of time or at a certain time or the interpreter (or computer system 12) automatically calls back the calling number at a certain time (step 63). Upon detection of disconnect between interpreter's communication device 15b or 17b and the member's communication device 15a (step 64), the Interpreter Database is updated for the interpreter by the computer system 12 to set the “Available?” to “yes”.

In the operation of system 10 use for members or institutions once the interpreter has been connected to the party in need of assistance, the interpreter can serve as an over-the-phone interpreter or answer questions and assist with issues such as directions, transportation, hotels, food and others. Over-the-phone interpretation can be accomplished with three-way calling, speaker phone, use of a second phone on the same line or passing the phone back and forth. The interpretations may be focused on meaning, rather than precise word-for-word interpretation.

As described earlier, billing may be done in one of several ways, including, but not limited to, toll number charges, billing credit card information which has been provided at signup, deduction from an account paid for and established at signup or billing to credit card information provided during the call or other prearranged credit or prepaid card. For the institution service, charges may go entirely to the institution, entirely to its customers or may be split in any way between them. A portion of the revenue may be shared with the institution. All charges may be made as a flat rate per contact or based on length of call by specific increments. Text messages may also be similarly charged.

The above embodiment described the user of the system 10 for connecting between a requesting party (e.g., member or customer) and an interpreter. In another embodiment of system 10, the requesting party provides a request to system 10 to connect with one or more other participants in a multi-party call in which the participants are conversant in two or more different languages and require thus one or more interpreters to be connected into the conference call. System 10 provides simultaneous language interpretation over telephone or voice lines or other audio communication link in conjunction with or without a Visual Display either on computer, light-emitting diodes or other electronically manipulated visual. The system works for conference calls and other electronically transmitted conversations of varying sizes and numbers of languages. This system provides uninterrupted conversation to each participant without the burden of hearing two speakers (i.e., a participant and an interpreter) speaking at once, opening and closing selected connections and/or adjusting the volume of sound on selected connections according to pre-selected settings and adjustments selected by the participants and depending on who is speaking at the moment,. The simultaneous interpretation allows conversation to flow smoothly and proceed efficiently.

Referring back to FIG. 1, multiple participants, three or more, may connect to computer system 12 via interface 14 or via network 16. Each participant is located at one of communication devices 15 or 17. Communication devices 17 used by network participants are labeled PN₁ to PN_{N}, where N is the number of participants using network 16. Communication devices 15 represent phone (cellular or land) participants are labeled P₁ to P_{M}, where M is the number of phone based participants. The total number of participants in a conference call either by telephony or by the network is thus N plus M. The computer system 12 enables a user, called herein an Organizer, to arrange a conference or conference call with remote interpretation among all participants designating which participants speak (are conversant) in a Main Language, and other(s) who speak (are conversant) in non-Main Language(s) with use of the simultaneous interpretation. The Main Language represents the primary language of the conversation as established by the Organizer. Participants speaking the Main Language do not use interpreters for the conversation. Each of the participants speaking a non-Main Language is selected by the computer system 12 using the Interpreter Database for an interpreter having a two language pair representing the participant's non-Main Language and the Main Language, has “Available?” set to “yes”. Preferably the interpreter selected has “Simultaneous” set to “yes” in the Interpreter Database. However, the Organizer may select rather than simultaneous interpretation to have consecutive interpretation, whereby the participant and his/her interpreter speak in turns rather than at the same time by appropriate selection of an interpreter in the Interpreter Database for the desired language pair with the “Simultaneous” set to “no” and “Consecutive” set to “yes”. If two of more participants speak the same non-Main Language, they may use the same interpreter for such non-Main Language. A non-Main Language participant may understand and/or speak the Main Language, but he or she prefers, for this conversation, to either only speak through an interpreter or both speak and listen through an interpreter. The same interpreters as described earlier at one or more of communication device 15b and 17b are connected into the conference call by the computer system 12 as described below. Although only two interpreters are shown there may be multiple interpreters at multiple ones of communication device 15b and 17b in system 10 for the different language pairs, and some interpreters provide the same language pairs. Alternatively, the Organizer may arrange remote interpretation to assist attendees at a conference. The requesting communication device 15a may represent one of the multiple participants in a multi-party call when calling-in to computer system 12 to be connected via a selected interpreter for interpreting between the Main Language, and the preferred language of such participant.

Participants are first contacted as to the date and time scheduled by the Organizer for the call to take place, and then call in prior to such time. Those participants designated as speaking the Main Language (identified as P₁ML, P₂ML, . . . or PₓML) are connected by their associated communication devices 15 or 17 to provide two-way communication with each other in a Main Language Circle (“MLC”), i.e., the link of constant connection of phone lines, other voice lines or other audio communication links for Main Language conversations to take place. It is a voice circuit on which all speech created and heard is in Main Language, and represents the base for the telephone call conversation.

As each Main Language participant calls in to the computer system 12 via their respective communication device 15 or 17 they are connected in the Main Language Circle by the computer system 12. As each non-Main Language participant calls in to the computer system 12 via their respective communication device 15 or 17 they are primarily connected to the conference call or conference via an interpreter who is connected to the Main Language Circle. Each participant designated as being a non-Main Language participant (identified as PₐL_{b} where Pₐ represents the number of the individual participant and L_{b} represents the language said participants speaks) non calls in with their respective communication device 15 or 17 to computer system 12 and is provided an available interpreter by the computer system 12 (such interpreter is designated as L₁I, L₂I, . . . L_{b}I, where the subscript numeral matches the language of the corresponding non-Main Language participant), and the interpreter is added to the Main Language Circle, and the non-Main Language participant is connected for a two-way conversation with the interpreter. The connection from the participant to the interpreter may be through the handset of a phone or a headphone worn or used by the interpreter. Thus, the voice communication from the participant is not directly transmitted to the MLC in the default settings. Such a system of voice lines connecting interpreters to the Main Language Circle, but not the non-Main Language participants, directly allow for simultaneous interpretation to some participants without the distracting voice of a non-Main Language participant. This is achieved by providing each non-Main Language participant with only an incoming connection from the Main Language Circle unless, in some circumstances, non-Main Language participant decides directly enter the Main Language Circle and bypass interpretation. The non-Main Language participant has both an outgoing and incoming connection to his interpreter either by a single or multiple lines. The interpreter has both an outgoing and incoming connection to the Main Language Circle. The connections from the Main Language Circle to the interpreter and from the non-Main Language participant to the interpreter are always open, because the interpreter must be able to hear what is happening. If non-Main Language participant chooses to listen to the Main Language Circle instead of his interpreter, then the call begins with an open line from the Main Language Circle to non-Main Language participant. If non-Main Language participant chooses to listen to interpreter instead of the Main Language Circle, then the call begins with an open line from interpreter to non-Main Language participant and a severely lowered volume on the line from Main Language Circle to the non-Main Language participant. When the computer system 12 recognizes sound on a connection (or line) from a non-Main Language participant to the interpreter (through voice activation or other means) the connection from the interpreter to the Main Language Circle is opened so that the interpreter can speak on behalf of his respective non-Main Language participant of his or her respective participant, and the line remains open for a short time after the participant finishes speaking. Also, when the non-Main Language participant presses a button requesting to speak, the line from the interpreter to MLC is open so that the interpreter can interpret what the participant says.

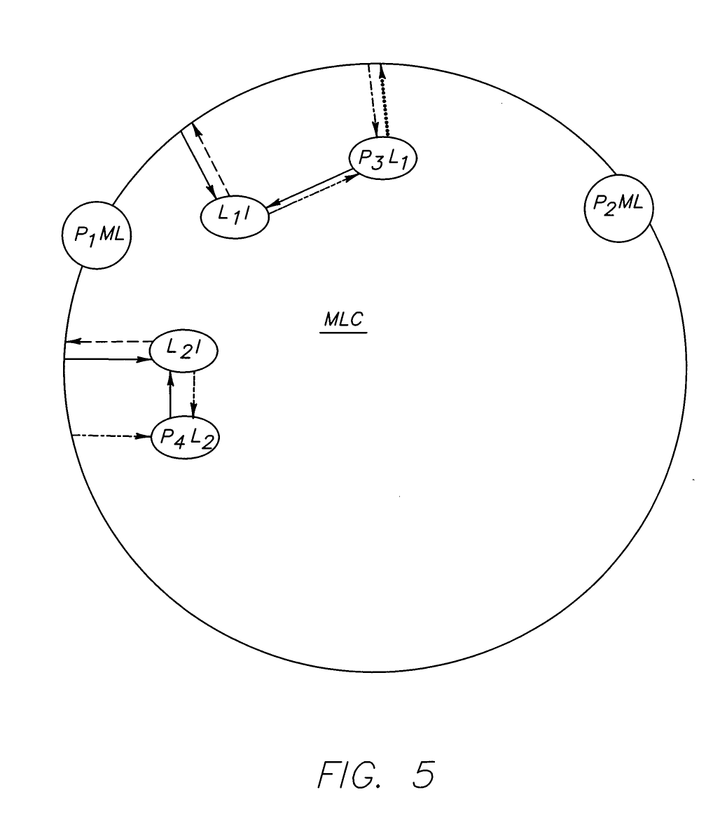

FIGS. 4-6 show examples of conference call connections or conference connections when remote interpretation is used. In these examples, solid line arrows represent a one-way connection to the MLC in the direction of such arrow. Dashed line arrows represent a one-way connection which is open only when the computer system 12 detects speech, and for a short time thereafter P₂L₁ finishes speaking, or chooses the option keep the line open for communication. Dotted line arrows represent a connection by non-Main Language participant which when active allows that participant to speak directly to the MLC, but is normally not active. Alternating dash and dot line arrows represent connection that is volume controlled by the non-Main Language participant, which normally is severely muted. In the example of FIG. 4, there is shown a Main Language Circle (MLC) with one Main Language-speaking participant (P₁ML, P_{f}ML designates a participant speaking in the main language and not using an interpreter), one non-Main Language participant (P₂L₁), and one interpreter (L₁I) for that non-Main Language participant. In the example of FIG. 5, there is shown a MLC with two participants (P₁ML and P₂ML) who speak the main language, two non-Main Language participants (P₃L₁ and P₄L₂) who speak Language 1 and Language 2, respectively, and one interpreter (L₁I) for P₃L₁ and another interpreter (L₂I) for P₄L₂.

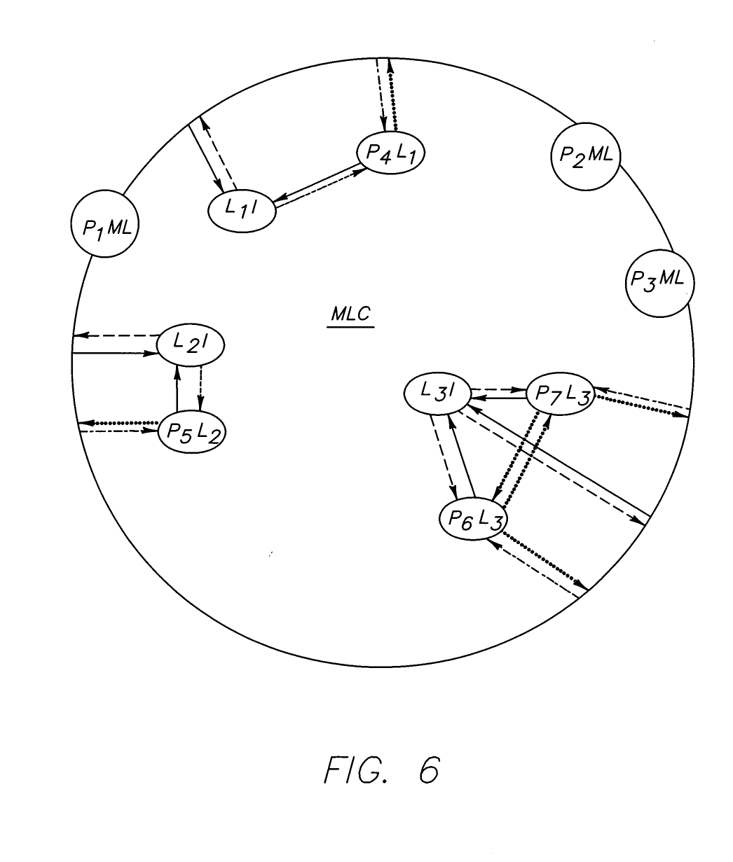

When there are two or more participants speaking the same language, one interpreter may assist more than one of these participants. In that case, the pre-call settings will determine if each participant listens primarily to others speaking the same language or to the interpretation of their speech. An example of this is in FIG. 6 which shows a MLC with three Main Language-speaking participants (P₁ML, P₂ML, and P₃ML), four non-Main Language participants speaking three different languages (P₄L₁, P₅L₂, P₆L₃, and P₇L₃), and three interpreters for the three languages (L₁, L₂, L₃) denoted by L₁I for participant P₄L₁, L₂I for participant P₅L₂, and L₃I for participants P₆L₃ and P₇L₃. Unlike the first two examples, the example of FIG. 6 there is a group of two non-Main Language participants who speak the same non-Main Language (L₃). The non-Main Language participants P₆L₃, and P₇L₃ may make pre-call settings to determine if they prefer to listen to each other speak or listen to the interpretation of what each other said. P₆L₃, and P₇L₃ can only choose to listen to each other if they already chose to listen to their interpreter instead of directly to the MLC. One interpreter thus assists two non-Main Language participants who speak the same language. The number of non-Main Language participants assigned to the same interpreter may be limited if needed according the language or the interpreter's capability. The computer system 12 has hardware and software for enabling the switching and bridging as described in these examples, and to switch on/off connections to provide one-way or two way connections between interpreters and participants, with adjustment of volume, as described above. Further operators 22 may be connected via their communication devices to the MLC or with individual participants via either interface 14 or via network 16, if a problem occurs during the conference, i.e., such as a lost connection to a participant, audio difficulties, or the like.

The communication device 15 or 17 of each participant may have a display through which the computer system 12 can provide information during the conference call, called herein a Visual Display. Where the participant uses a communication device 17, device 17 may be part of a computer system having a browser for enabling a participant to connect via network 16 to computer system 12, for enabling one or more of notification of the conference call (e.g., e-mail), call-in to a network address of the web site associated with the conference to be established by the computer system 12, or receive information about the conference via a Visual Display. Such Visual Display may represent web page(s) downloaded from the computer system, or other on screen indicators.

The Visual Display, preferably a computer program or downloaded web page(s) from the computer system 12 which are updated by the computer system with conference information. The Visual Display identifies speaking participants (via highlighted, flashing, or other notification related to displayed text, graphics, or photos of participants), and/or has selectable buttons, field, or other graphics, to send input to the computer system to effect the participant connections (e.g., volume control, opening two-way commutation to MLC) that allows for manipulation of the settings of various lines of the given participant. If the display is a website page, the website page will be tailored specifically for that call, showing the name of each Participant placed in its own graphic around one large circle. When a Participant is speaking, the graphic demarking that Participant may be highlighted and enlarged. The web page may contain other features for assistance and adjusting settings. Other variations of visuals may display the current speaker and also provide functions that allow for adjustments of the settings, and are not limited to those described herein. Although a participant may use communication device 15, such communication device may not be able to receive web pages providing the Visual Display, as such the participant with communication device 15 may utilize a computer system, such as computer system 17a at his or her location to log-in and obtain a Visual Display, but where voice communication is via their communicating device 15. The Visual Display may feature an assistance button that any participant can press to immediately notify all Participants and interpreters that a Participant is having a problem and the conversation must be delayed. When the assistance button is pressed, an employee of the system operator or an employee of a contractor or licensee may join the conversation to assist, with interpreters providing the necessary interpretation.

The visual display may include controls for adjusting the volume coming from the MLC and (for a non-Main Language participant) coming from the interpreter and others speaking the same non-Main Language. All of these can be fully muted as well, at the Participant's discretion, at any point in the call.

Another feature of the Visual Display an option to notify others that the participant chooses to speak. It is not required, but can be useful, especially for non-Main Language participants who may otherwise be cut off. In any case, the line from the interpreter to the MLC opens automatically upon voice activation once the non-Main Language participant begins speaking and stays open for a short time after the non-Main Language participant stops speaking to allow the interpreter to speak to the MLC.

As an additional option on the Visual Display, a non-Main Language participant may be able to override the interpretation system and speak directly to MLC by utilizing an override option on the Visual Display.

This Visual Display may also provide a button for logging out of the conversation. It may provide other information or features as well.

Alternatively, or in additional to the Visual Display provided on the screen of communication device 17 having web access to computer system 12, an optional external Visual Display unit 18 may be used which at least identifies the speaking participant in the conference in a manner similar to the Visual Display just described above. This external Visual Display unit 18 may be an LCD display, CRT display, or projector onto a surface, connected to computer system 17a, to computer system 12, or to network(s) 16 to receive output graphical screen or window generated by computer system 12. For example, external Visual Display unit 18 may be in a common room with one or more of the participants, and a conference may have one or more external Visual Displays. The external Visual Display unit may also be a unit associated with a given participant having light emitting diode(s) (“LED”) or array or LEDs, or screen, or other electronically manipulated visual that identifies speaking participants and/or allows for manipulation of settings of various lines of the given participant. For example, different LED or Array may be associated with each different speaker and be provided to a participant of the conference. The computer system sends graphics to the unit's screen or actuates LEDs thereof as speakers change, and knob(s) or button(s) may be provided on the unit to control volume or connections at his or her respective communication device 15 or 17 with the Interpreter and/or MLC.

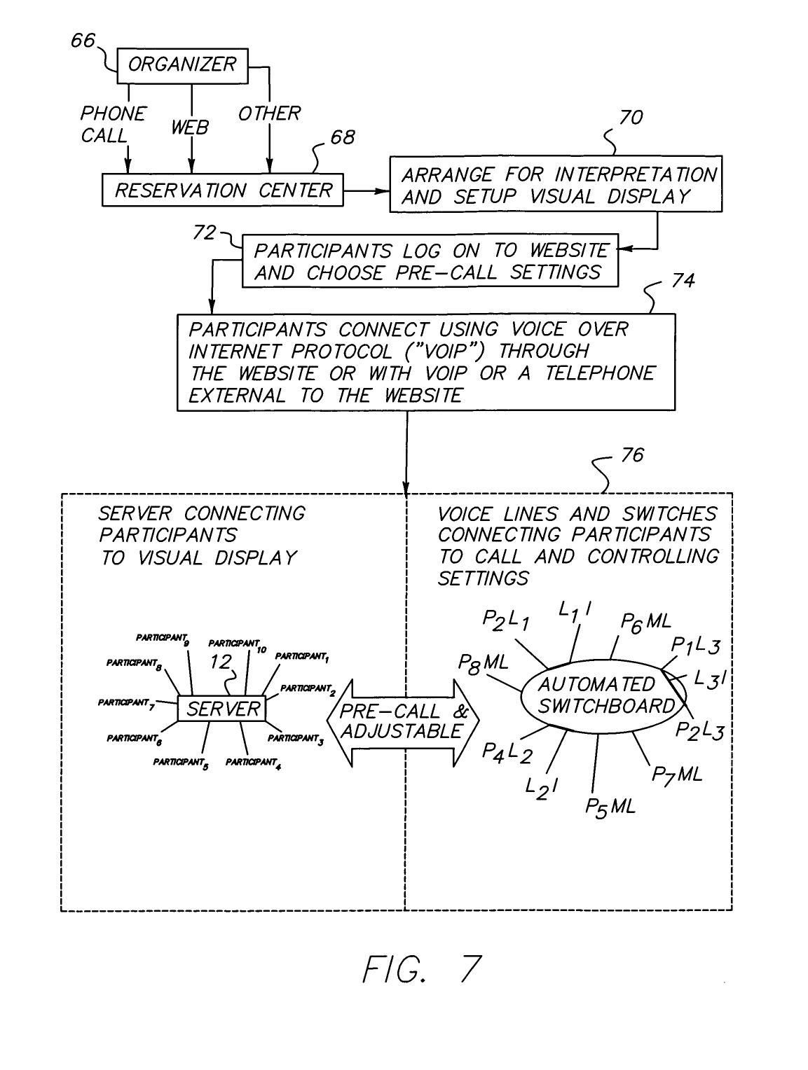

Referring to FIG. 7, the operation of the system for conferencing having participants with two or more different languages and one or more interpreters is shown. First, Organizer 66 make a reservation in system 10 at a reservation center 68, i.e., address of a web site, or assigned phone number of automatic or human operator. The Organizer 66 prearranges the conversation, either by calling to make reservations, or completing an online form at a web site for system 10. At that time, the Organizer also chooses the Main Language of the conference, provides the number of participants and which participants speak which language. Although preferably interpretation type is simultaneous for non-Main Language participants, the Organizer may optionally select for a non-Main Language participant to provide for simultaneous or consecutive interpretation. The Organizer pays for the service or arranges for future payment. In one example, the Organizer is located at computer system 17a having a browser. The Organizer enters an address associated with a web site of system 10 at computer system 12 to connect computer system 17a via network 16, such as the Internet, to computer system 12. In response, computer system 12 sends one or more web pages to computer system 17a having fields to enter conference information in a conference request form. Conference information in addition to designated main language and the number of participants, name of organizer, and payment (billing) information, or other information (e.g., interpretation type), but also for each participant one or more identifying information, such as e-mail address, name, phone number, or a pass-code. In another example, the Organizer uses a phone (cellular or land phone) contacts the computer system 12 at a phone number assigned to system 10, via interface 14, and is led through automated prompts via phone keys (or voice) to enter the conference information. In a further example, a human operator at a computer system 17a is connected to an Organizer calls the system 10 on a phone, and the operator enter the information in web pages rather than the Organizer.

Once reservations are complete, the computer system 12 provides the Organizer information (such as via an acknowledging web page at computer system 17, or by automated voice via phone) to forward to (or otherwise inform) the participants with instructions as to how to connect to the arranged conversation, or the Organizer provides contact information (e.g., e-mail address) for each participant so that computer system 12 via automatic voice call and/or human operator can instruct participants in connecting to the call. The entire process may be automated. The Organizer may or may not be one of the participants.

At step 70, prior to the scheduled time and date of the call, such as 5 to 10 minutes before, the computer system 12 selected the interpreters using the Interpreter Database for the language pairs between each non-Main Language and Main Language needed for a scheduled conference call. The Interpreter Database is updated by the computer system 12 automatically updates in real-time the status of the interpreters. This is accomplished by adjusting the Interpreter Database for the future, so that, by example, when there is a scheduled multi-party conference requiring remote interpretation in at 5:00 pm Eastern Standard Time, and the on duty interpreters for that time are known by 8:00 am Eastern Standard Time, the system can automatically reserve the appropriate interpreters in advance, scheduling the interpreters to begin a few minutes early so that it is assured they will be available at the start of the call. This is done by taking a snap shot of the Interpreter Database as it will be at 5:00 pm, or perhaps 4:45 pm, to be assured the interpreters will be available at 5:00 pm, and then changing the “Available?” for that time to “no” and marking that the system will connect that interpreter to specified participant(s) at that time. Also at step 70, the computer system 12 also sets-up the in-call web page for the Visual Display graphics, as described earlier, to be sent to those Participants whose communication device can receive such Visual Display after they log-in for the conference call.

The participants each call into the computer system, via interface 14, or sign-in (or log on) to a web page provided by the computer system via network 16, prior to the time of schedules conference time (step 72). For example, the web page(s) provided by computer system 12 to the computer system of participants at the sign-in (or log on) may be available in multiple languages approximately five to ten minutes before the scheduled conference c and provides identifying information (either an email address, a name, a phone number or a pass-code) to the computer system 12 who the participant is, which call the participant will be connecting to, whether that participant needs interpretation, and, if so, in what language. Each of the participants may be considered as one of a plurality of requesting communication devices for a particular conference call.

In the event a Visual Display is used and the participant connected to the computer system 12 is a sign-in or log-in page, in-call web page for the Visual Display graphics is generated as described earlier denoting the participants in the conference call. If the participant is a Main Language participant, the computer system 12 connects the participant to the in-call web page to wait for the start of the call. Voice communication will be through the computer system being used by the participant, such as via VoIP, which has hardware (speaker or microphone) and software to enable such communication. Optionally, where the participant calls in is from a phone 15 via interface 14, the participant is instructed to wait for the conference to begin.

If the participant is a non-Main Language participant, the computer system 12 prompts the participant to establish settings for the call and requests the participant via web page (or voice prompts):
1) If he/she would a) like to hear interpretation of each participant conversing the in the Main Language or b) he/she is capable and would prefer to listen to such participants himself/herself.
   If the answer to (1) is (a) and if there is at least one other participant speaking the same language, then the participant is asked question (2).
2) If he/she would like to listen directly to others who speak his/her language when they speak or if he/she prefers to hear the interpretation heard by the rest of the participants? (This question assumes there are multiple Participants speaking the same language other than the Main Language). The default setting if there are two more non-Main Language participants speaking is to provide a connection between them that enables them to hear each other, rather than through their interpreter to the Main Language Circle.

After the settings for the non-Main Language participants are entered, the computer system 12 sends the non-Main Language participant the Visual Display (if there is one) to await the start of the call.

Once the computer system 12 identifies the participants and obtains information as to the pre-call settings for non-Main Language participants described above (step 72), the computer system 12 connects each of the participants, such as described earlier respect to the example of FIGS. 4-6, for phone or VoIP communication depending on the type of communication device 15 or 17 used by respective participants (step 74). This involves computer system 12 connecting the Main Language participants respective communication device 15 or 17 in the Main Language Circle, and each non-Main Language participant via their respective communication device 15 or 17 to the Main Language Circle via a selected interpreter for pair of the participant's non-Main Language and the Main Language who is available, and has desired Simultaneous or Consecutive setting (step 76). The Visual Display of the communication device 15 or 17, or external Visual Display unit 18 facilitates the participant to identify who is speaking directly or through an Interpreter.

As each non-Main Language participant disconnected from their associated interpreter, and the interpreter has no other connected non-Main Language participant, the Interpreter Database is updated. Once an interpreter is no longer connected to the conference, the “Available?” for that interpreter in the Interpreter Database is switched to “yes.”

The preferred embodiment of interpretation for such conference conversations is the one described above. The following variations may be provided in system 10 for conference calls or conferences for which remote interpretation is used:

1) The interpreter may control who is able to hear the interpreter's outgoing speech by toggling between an open line to the conversation or an open line to the non-Main Language participant. A switch provided as a hardware attachment to the audio lines at the interpreter's communication device, which can be controlled by the interpreter by pressing keys on the communication device, or an external manual switch. This may or may not completely shut off the line through which the interpreter wishes to speak at that moment.

2) The interpreter uses two separate audio lines. In the case of using telephone lines, the interpreter could simply use two phones and speak into only one at a time, or the interpreter could switch back and forth between phone lines with a switch on a two-line system. While the interpreter is speaking in one direction, the interpreter may or may not have the ability and choose to listen to the other voice(s) coming from the other direction. The line from the interpreter to the non-Main Language participant may be unidirectional.

3) The interpreter and non-Main Language participant both connect to the conversation, but they also connect to each other with a separate, bidirectional line, and they use that separate line to communicate amongst themselves. In that situation they can switch between lines with a switch on a two-line system or simply speak into the correct microphones or telephones while covering the others or holding them

Furthermore, in situations such as a conference in which interpreter is providing remote interpretation of proceedings or in a conference call in which non-Main Language participant is simply listening to the conversation and is not and will not be speaking in the conversation, the system can be established with a unidirectional line from the conversation to the interpreter and a (unidirectional or controlled bidirectional) line between the interpreter and non-Main Language participant.

Where there are two participants conversant in two different languages, and said selected interpreter is selected by said computer system using said second database to interpret between the Main Language and the non-Main Language, as such the computer system 12 may connect communication devices two participants with the selected interpreter in a three-way call with typical two-way connection between all participants or with such connections and volume control of the FIG. 4 example. In this scenario, a simple three-way call, with or without volume and directional controls, is employed.

In summary, system 10 in a preferred embodiment has three databases: Regional Language Database, Interpreter Database, and Membership/Institution Database; a computer server(s) 12 with memory space for the databases and operations, an automated switching panel and necessary equipment to switch on/off the voices and adjust the volume of participants and interpreters when necessary in the multi-party, conference scenarios and to connect members with interpreters in all situations; lines and other equipment for connecting the voice and data transmissions to and from the server and switches; a computer server and website for the web-based operations which may be the same or separate from computer server 12; Visual Display which may be web-based or light-emitting diodes or colored lights of an external Visual Display 18 indicating which participants are speaking in the multi-party, conference scenarios; assistance agents 22 seated at computers to help when the assistance button is used in the multi-party, conference scenarios; interpreters 15b or 17b with voice lines, these interpreters may be in a virtual call-center, meaning they can be located anywhere and separately as long as they are each available by voice line (including by telephone, by voice over internet protocol or “VOIP” or by other voice transmission system) at the scheduled time; voice lines for the assistance agents and interpreters 15b or 17b, this may include telephone, VOIP or other voice transmission system; and VOIP, if implemented in the system 10.

From the foregoing description, it will be apparent that an improved system and method for interpreter selection and connection to communication devices for single party in the case of a voice call or text message, or for selecting interpreter(s) for participant(s) in a multi-party call having participants conversant in two or more different languages. Variations and modifications in the herein described system and method will undoubtedly become apparent to those skilled in the art. According the foregoing description should be taken as illustrative and not in a limiting sense.

1. A system for automatic selection of an interpreter comprising:
a computer system having memory and one or more interfaces enabling communication with one or more communication devices, in which said computer system is capable of determining geographic region associated with the location of said one or more communication devices;
a first database stored in said memory having identifying information to identify the communication device of each of a plurality of users, and associating a plurality of said users with one or more languages of the users;
a second database stored in said memory associating geographic regions with different languages;
a third database stored in said memory associating interpreters with pairs of different languages each of said interpreters are capable of interpreting between; ; and
said computer system in response to a requesting communication device, identifies the requesting communication device with one of said plurality of users in accordance said identifying information of said first database, determines a geographic region associated with the requesting communication device, selects one of said languages associated with the geographic region associated with the requesting communication device in accordance with said second database, and selects an interpreter associated with one of said pairs of said selected language and one of the one or more languages of the identified one or said plurality of user for connection with the requesting communication device in accordance with said third database.

2. The system according to claim 1 wherein said requesting communication device provides a voice call to said computer system, and said computer system connects the communication device of the selected interpreter with said requesting communication device for enabling voice communication between the requesting communication and the communication device of said selected interpreter.

3. The system according to claim 1 wherein said requesting communication device provides a text message to said computer system, and said computer system connects the communication device of the selected interpreter with said requesting communication device for enabling text messaging between the requesting communication and the communication device of said selected interpreter.

4. The system according to claim 1 wherein said third database further has information relating to availability of each of said interpreters for connection to the requesting communication device, and said computer system selects said interpreter available in accordance with said third database.

5. The system according to claim 1 wherein:
said requesting communication device represents one or a plurality of communication devices associated with participants in a conference;
one or more of said participants conversant in a main language each have a communication device with a two-way connection for enabling conference with each other; and
each of said one or more participants conversant in a different language than the main language have a communication device with a two way connection with a communication device of an interpreter selected for interpreting between one of the pairs of the different language and said main language in accordance with said third database, in which the communication device of the selected interpreter has a two-way communication with the conference.

6. The system according to claim 5 wherein the communication device of each of said one or more participants conversant in a different language than the main language has a one-way receive only connection with the conference in said main language.

7. The system according to claim 5 wherein the communication device of each of said one or more participants conversant in a different language than the main language has a one-way receive only connection with the conference in said main language at a volume level adjustable at the communication device by the participant.

8. The system according to claim 5 wherein said communication device of each of said one or more participants conversant in a different language than the main language is selectable between one of a one-way receive only connection and a two-way connection with the conference in said main language.

9. The system according to claim 5 wherein the communication device of one or more of said participants represents a microprocessor-based system operative to provide two-way voice communication, and said microprocessor-based system has a display identifying each of the participants and when each one of said participants is speaking.

10. The system according to claim 9 wherein said microprocessor-based system has an interface to enable one of said participants to notify other of said one or more participants in the conference of an intention to speak in the conference.

11. A system for automatic selection of an interpreter comprising:
a computer system having memory and one or more interfaces enabling communication with one or more communication devices, and said computer system is capable of presenting to a caller on the communication device one of a plurality of different languages;
a first database stored in said memory having identifying information to identify each of a plurality of users, and associating a plurality of said users with one or more languages of the users;
a second database stored in said memory associating interpreters with pairs of different languages each of said interpreters are capable of interpreting between; and
said computer system in response to a call of a requesting communication device, identifies one of said plurality of users in accordance said identifying information of said first database, enables a caller on the communication device to select one of a plurality of different languages, and selects an interpreter associated with one of said pairs of said caller selected language and one of the one or more languages of the identified one or said plurality of user for connection with the requesting communication device in accordance with said second database.

12. A method for automatic selection of an interpreter comprising the steps of:
providing a computer system and a database associating interpreters with pairs of different languages each of said interpreters are capable of interpreting between selecting one of the languages associated with one of a caller of the requesting communication device or a geographic region associated with the requesting communication device;
selecting an interpreter automatically in accordance with said a database for interpreting between one of the pairs of said selected language and one or more predetermined languages; and
connecting the interpreter with the requesting communication device.

13. A system for automatic selection of an interpreter comprising:
a computer system and a database associating interpreters with pairs of different languages each of said interpreters are capable of interpreting between;
said computer system having means for selecting one of the languages associated with one of a caller of the requesting communication device or a geographic region associated with the requesting communication device, and means for selecting an interpreter in accordance with said a database for interpreting between one of the pairs of said selected language and one or more predetermined languages; and
connecting the interpreter with the requesting communication device.

14. A system for automatic selection of interpreters for a conference of participants conversant in different languages comprising:
a computer system capable of communicating with one or more communication devices and connecting two or more of said communication devices for voice communication, in which said computer system has memory storing information for associating interpreters with pairs of different languages each of said interpreters are capable of interpreting between; and
said computer system in response to a request for establishing a conference of a plurality of participants conversant in two or more different languages, in which each of said plurality of participants has a communication device for connection to the computer system, the computer system provides a two-way connection for enabling conference with each other of one or more of said participants conversant in a main language, and for each of said one or more participants conversant in a different language than the main language provides a two way connection with a communication device of the participant with a communication device of an interpreter selected for interpreting between one of the pairs of the different language and said main language in accordance with said database, and provides a two-way connection between the communication device of the selected interpreter and the conference.

15. The system according to claim 14 wherein the communication device of each of said one or more participants conversant in a different language than the main language has a one-way receive only connection with the conference in said main language.

16. The system according to claim 14 wherein the communication device of each of said one or more participants conversant in a different language than the main language has a one-way receive only connection with the conference in said main language at a volume level adjustable at the communication device by the participant.

17. The system according to claim 14 wherein said communication device of each of said one or more participants conversant in a different language than the main language is selectable between one of a one-way receive only connection and a two-way connection with the conference in said main language.

18. The system according to claim 15 wherein the communication device of one or more of said participants represents a microprocessor-based system operative to provide two-way voice communication, and said microprocessor-based system has a display identifying each of the participants and when each one of said participants is speaking.

19. The system according to claim 18 wherein said microprocessor-based system has an interface to enable one of said participants to notify other of said one or more participants in the conference of an intention to speak in the conference.

20. The system according to claim 18 wherein said display represents an external display connected to one of said microprocessor-based system or said computer system.
